(19) United States
(12) Patent Application Publication
(10) Pub. No.: US 2004/0177288 A1
(43) Pub. Date: Sep. 9, 2004

(54) Apparatus and method for capturing the program counter address associated with a trigger signal in a target processor

(76) Inventor: Gary L. Swoboda, Sugar Land, TX (US)

Correspondence Address: TEXAS INSTRUMENTS INCORPORATED, P O BOX 655474, M/S 3999, DALLAS, TX, 75265

(21) Appl. No.: 10/729,400

(22) Filed: Dec. 5, 2003

Related U.S. Application Data
(60) Provisional application No. 60/434,135, filed on Dec. 17, 2002.

(51) Int. Cl. H04L 1/22

(52) U.S. Cl. 714/39

(57) ABSTRACT

In a target processor, trigger signals that result in changes in the program execution must be identified and communicated to a host processing unit. The target processor uses the generation of a trigger signal by preselected events to store the indicia of the preselected events in a register for transfer to the host processing unit. The program counter contents related to the trigger signal is delayed to accommodate the target processor delay and stored when a trigger signals is generated.

This application claims priority under 35 USC §119(e)(1) of Provisional Application No. 60/434,135 (TI-34661P) filed Dec. 17, 2002.

### RELATED APPLICATIONS

U.S. patent application (Attorney Docket No. TI-34654), entitled APPARATUS AND METHOD FOR SYNCHRONIZATION OF TRACE STREAMS FROM MULTIPLE PROCESSORS, invented by Gary L. Swoboda, filed on even date herewith, and assigned to the assignee of the present application; U.S. patent application (Attorney Docket No. TI-34655), entitled APPARATUS AND METHOD FOR SEPARATING DETECTION AND ASSERTION OF A TRIGGER EVENT, invented by Gary L. Swoboda, filed on even date herewith, and assigned to the assignee of the present application; U.S. patent application (Attorney Docket No. TI-34656), entitled APPARATUS AND METHOD FOR STATE SELECTABLE TRACE STREAM GENERATION, invented by Gary L. Swoboda, filed on even date herewith, and assigned to the assignee of the present application; U.S. patent application (Attorney Docket No. TI-34657), entitled APPARATUS AND METHOD FOR SELECTING PROGRAM HALTS IN AN UNPROTECTED PIPELINE AT NON-INTERRUPTIBLE POINTS IN CODE EXECUTION, invented by Gary L. Swoboda and Krishna Allam, filed on even date herewith, and assigned to the assignee of the present application; U.S. patent application (Attorney Docket No. TI-34658), entitled APPARATUS AND METHOD FOR REPORTING PROGRAM HALTS IN AN UNPROTECTED PIPELINE AT NON-INTERRUPTIBLE POINTS IN CODE EXECUTION, invented by Gary L. Swoboda, filed on even date herewith, and assigned to the assignee of the present application; U.S. patent application (Attorney Docket No. TI-34659), entitled APPARATUS AND METHOD FOR A FLUSH PROCEDURE IN AN INTERRUPTED TRACE STREAM, invented by Gary L. Swoboda, filed on even date herewith, and assigned to the assignee of the present application; U.S. patent application (Attorney Docket No. TI-34660), entitled APPARATUS AND METHOD FOR CAPTURING AN EVENT OR COMBINATION OF EVENTS RESULTING IN A TRIGGER SIGNAL IN A TARGET PROCESSOR, invented by Gary L. Swoboda, filed on even date herewith, and assigned to the assignee of the present application; U.S. patent application (Attorney Docket No. TI-34662), entitled APPARATUS AND METHOD DETECTING ADDRESS CHARACTERISTICS FOR USE WITH A TRIGGER GENERATION UNIT IN A TARGET PROCESSOR, invented by Gary Swoboda and Jason L. Peck, filed on even date herewith, and assigned to the assignee of the present application; U.S. patent application (Attorney Docket No. TI-34663), entitled APPARATUS AND METHOD FOR TRACE STREAM IDENTIFICATION OF A PROCESSOR RESET, invented by Gary L. Swoboda, Bryan Thome and Manisha Agarwala, filed on even date herewith, and assigned to the assignee of the present application; U.S. patent (Attorney Docket No. TI-34664), entitled APPARATUS AND METHOD FOR TRACE STREAM IDENTIFICATION OF A PROCESSOR DEBUG HALT SIGNAL, invented by Gary L. Swoboda, Bryan Thome, Lewis Nardini and Manisha Agarwala, filed on even date herewith, and assigned to the assignee of the present application; U.S. patent application (Attorney Docket No. TI-34665), entitled APPARATUS AND METHOD FOR TRACE STREAM IDENTIFICATION OF A PIPELINE FLATTENER PRIMARY CODE FLUSH FOLLOWING INITIATION OF AN INTERRUPT SERVICE ROUTINE; invented by Gary L. Swoboda, Bryan Thome and Manisha Agarwala, filed on even date herewith, and assigned to the assignee of the present application; U.S. patent application (Attorney Docket No. TI-34666), entitled APPARATUS AND METHOD FOR TRACE STREAM IDENTIFICATION OF A PIPELINE FLATTENER SECONDARY CODE FLUSH FOLLOWING A RETURN TO PRIMARY CODE EXECUTION, invented by Gary L. Swoboda, Bryan Thome and Manisha Agarwala filed on even date herewith, and assigned to the assignee of the present application; U.S. patent application (Docket No. TI-34667), entitled APPARATUS AND METHOD IDENTIFICATION OF A PRIMARY CODE START SYNC POINT FOLLOWING A RETURN TO PRIMARY CODE EXECUTION, invented by Gary L. Swoboda, Bryan Thome and Manisha Agarwala, filed on even date herewith, and assigned to the assignee of the present application; U.S. patent application (Attorney Docket No. TI-34668), entitled APPARATUS AND METHOD FOR IDENTIFICATION OF A NEW SECONDARY CODE START POINT FOLLOWING A RETURN FROM A SECONDARY CODE EXECUTION, invented by Gary L. Swoboda, Bryan Thome and Manisha Agarwala, filed on even date herewith, and assigned to the assignee of the present application; U.S. patent application (Attorney Docket No. TI-34669), entitled APPARATUS AND METHOD FOR TRACE STREAM IDENTIFICATION OF A PAUSE POINT IN A CODE EXECTION SEQUENCE, invented by Gary L. Swoboda, Bryan Thome and Manisha Agarwala, filed on even date herewith, and assigned to the assignee of the present application; U.S. patent application (Attorney Docket No. TI-34670), entitled APPARATUS AND METHOD FOR COMPRESSION OF A TIMING TRACE STREAM, invented by Gary L. Swoboda and Bryan Thome, filed on even date herewith, and assigned to the assignee of the present application; U.S. patent application (Attorney Docket No. TI-34671), entitled APPARATUS AND METHOD FOR TRACE STREAM IDENTIFCATION OF MULTIPLE TARGET PROCESSOR EVENTS, invented by Gary L. Swoboda and Bryan Thome, filed on even date herewith, and assigned to the assignee of the present application; and U.S. patent application (Attorney Docket No. TI-34672 entitled APPARATUS AND METHOD FOR OP CODE EXTENSION IN PACKET GROUPS TRANSMITTED IN TRACE STREAMS, invented by Gary L. Swoboda and Bryan Thome, filed on even date herewith, and assigned to the assignee of the present application are related applications.

### BACKGROUND OF THE INVENTION

1. Field of the Invention

This invention relates generally to the testing of digital signal processing units and, more particularly, to the detection of events in a target processor that result in the generation of a trigger signals. The trigger signal events must be related to the program execution and transferred to a host processing unit for test and debug purposes.

2. Description of the Related Art

As microprocessors and digital signal processors have become increasingly complex, advanced techniques have been developed to test these devices. Dedicated apparatus is available to implement the advanced techniques. Referring to FIG. 1A, a general configuration for the test and debug of a target processor is shown. The test and debug procedures operate under control of a host processing unit 10. The host processing unit 10 applies control signals to the emulation unit 11 and received (test) data signals from the emulation unit 11 by cable connector 14. The emulation unit 11 applies control signals to and receives (test) signals from the target processing unit 12 by connector cable 15. The emulation unit 11 can be thought of as an interface unit between the host processing unit 10 and the target processor 12. The emulation unit 11 must process the control signals from the host processor unit 10 and apply these signals to the target processor 12 in such a manner that the target processor will respond with the appropriate test signals. The test signals from the target processor 12 can be a variety types. Two of the most popular test signal types are the JTAG (Joint Test Action Group) signals and trace signals. The JTAG signal provides a standardized test procedure in wide use. Trace signals are signals from a multiplicity of junctions in the target processor 12. While the width of the bus interfacing to the host processing unit 10 generally have a standardized width, the bus between the emulation unit 11 and the target processor 12 can be increased to accommodate the increasing complexity of the target processing unit 12. Thus, part of the interface function between the host processing unit 10 and the target processor 12 is to store the test signals until the signals can be transmitted to the host processing unit 10.

Referring to FIG. 1B, the operation of the trigger generation unit 19 is shown. At least one event signal is applied to the trigger generation unit 19. Based on the event signals applied to the trigger generation unit 19, a trigger signal is selected. Certain events and combination of events, referred to as an event front, generate a selected trigger signal that results in certain activity in the target processor such as a debug halt. Combinations of different events generating trigger signals are referred to as jobs. Multiple jobs can have the same trigger signal or combination of trigger signals. In the test and debug of the target processor, the trigger signals can provide impetus for changing state in the target processor or for performing a specified activity. The event front defines the reason for the generation of trigger signal.

In the test and debug of the target processor, part of the test apparatus monitors conditions within the target processor. Typically, monitored conditions are selected by the user. As a result of the monitoring, when the selected condition is identified, an event signal is generated. This signal or a combination of event signals is applied to a trigger unit. When the appropriate event signal or combination of event signals are applied to the trigger unit, a change in the operation of the target processor result. For example, the trigger unit may initiate a interrupt, a debug halt, or some other activity. The reason for the change in the operation of the target processor is frequently necessary to perform the test and debug analysis.

A need has been felt for apparatus and an associated method having the feature that the instruction generating or coordinated with the generation of a trigger signal is identified. It would be yet another feature of apparatus and associated method to identify the instruction in the code that resulted in or was coordinated with the generation of the trigger event. It would be a still further feature of the present invention to transfer the identity of the instruction coordinated with the generation of the trigger signal to the host processing unit for analysis. It would be a still further feature of the present invention account for the delay between the instruction coordinated with the trigger signal and the generation of the trigger signal. It would be a yet further feature of the present invention present invention to identify the program counter address coordinated with the generation of a trigger signal.

### SUMMARY OF THE INVENTION

The aforementioned and other features are accomplished, according to the present invention, by providing a capture register coupled to the program counter address. When the trigger signal is generated by the trigger generation unit, the trigger generation unit also applies a control signal to the capture register. The applied control signal results in the capture register can then store the program counter address. Because of the delay due to the execution of an instruction by a pipeline or the delay resulting from a pipeline flattener unit, a delay line with the appropriate delay insures that the program counter address stored in the capture register is coordinated with the generation of the trigger signal. The contents of the capture register can then be transferred to the host processing unit for analysis by JTAG or other methods. Similarly, the contents of the event signals resulting in the trigger signal can be stored in a separate capture register and transferred to a host processing unit.

Other features and advantages of present invention will be more clearly understood upon reading of the following description and the accompanying drawings and the claims.

### BRIEF DESCRIPTION OF THE DRAWINGS

FIG. 1A is a general block diagram of a system configuration for test and debug of a target processor, while FIG. 1B illustrates the function of the trigger unit.

FIG. 2, a block diagram of the apparatus for storing the event signals that result in the generation of a trigger signal.

FIG. 3 is a block diagram of apparatus for storing the contents of the program counter related to the generation of the trigger signal according to the present invention.

### DESCRIPTION OF THE PREFERRED EMBODIMENT

### 1. Detailed Description of the Figures

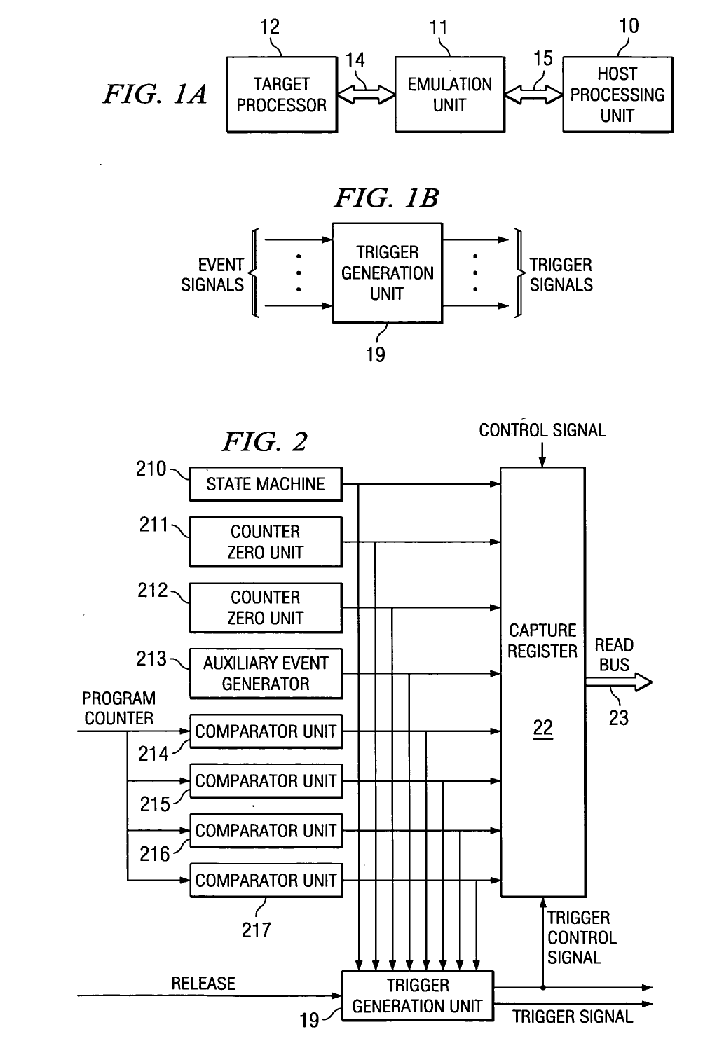

FIG. 1 has been described with respect to the related art.

Referring to FIG. 2, a block diagram of the apparatus for capturing the identification of the events resulting in a trigger signal is shown. A plurality of target processing unit and test and debug components can provide an event signal under preselected conditions. The components generating event signals include a state machine 210 (determining the state in which the target processing unit is executing code), counter zeros unit 211 and 212 (determining when a preselected condition has been met) an auxiliary event generating unit 213 (providing an event signal for a predetermined condition of the target processor), and comparators 214-217 (for identifying program counter generated events). Each of the components providing event signals are coupled to a particular input terminal of trigger generating unit 19 and to an associated location in the capture register 22. When an event signal or preselected combination of event signals is identified by the trigger generation unit 19, an appropriate trigger signal is generated. Along with the trigger signal, the trigger generation unit 19 generates a control signal. The control signal results in the storage of the applied event signals in the capture register 22. The contents of the capture register 22 can be applied to a read bus 23 and subsequently transferred to the host processing unit for analysis.

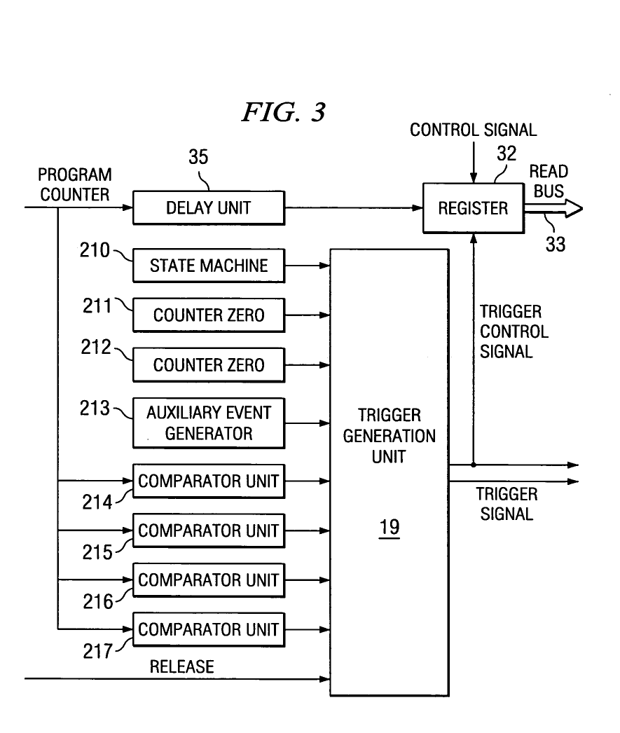

Referring to FIG. 3, a block diagram of the apparatus for storing the contents of the program counter related to the generation of a trigger signal is shown. As in FIG. 2, the state machine 210, the counter zero units 211 and 212, the auxiliary event generator 213, and the comparators, 214-217, in the presence of preselected conditions, generate event signals that are applied to the trigger generation unit 19. In response to a preselected event signal or combination of event signals, the trigger generation unit 19 generates a trigger signal. The trigger signal causes a predetermined response by the target processor. In addition, the trigger generation unit 19 provides a control signal. This control signal is applied to register 32. The contents of program counter are applied through a delay line 35 to the register 32. In response to the trigger control signal, the program counter contents are stored in the register 32. In response to a control signal, the contents of register 32 can be transferred to the host processing unit.

### 2. Operation of the Preferred Embodiment

In analyzing the operation of target processing system, it is important to know the portion of the executing program that resulted in the generation of a trigger signals and the resulting change in program execution. The present invention captures a program counter address that is coordinated with the change in operation, e.g., the transition to and interrupt service routine. This program counter address is captured only in the event that an actual trigger signal is generated. Upon the generation of a trigger signal, signals specifying the program counter address related to the trigger signal is stored in the capture register. The capture register is typically a memory-mapped register whose contents are available to the host processing unit. The register contents can therefore be transferred the host processing unit for analysis. In addition to the location in the program execution that provided the trigger signal, it is necessary to determine the particular events that resulted in the generation of the trigger signal. Consequently, a second capture register is provided to capture the event signals applied to the trigger generation unit. As with the program counter address capture, the event signal capture is performed in response to the generation of a control signal that is provided when the trigger signal is provided. The event capture register is also a memory-mapped register so that the contents of the event capture register can be accessed by the host processing unit. With the combination of the identified event signals and the point in the program execution when the trigger signal occurred, the host processing unit using test and debug techniques can frequently determine the reason for the generation of the trigger signal.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. In a target processor, apparatus for storing a program counter address related to the generation of the a trigger signal, the apparatus comprising:
a trigger generation unit coupled to the plurality of event signal generation units, the trigger generation unit responsive to at least one preselected event signal for generating an associated trigger signal, the trigger generating unit also generating a trigger control signal;
a register, the register having program counter address related to the trigger signal applied thereto, the register storing the program counter address in response to a control signal generated by the trigger generation unit when the trigger signal is generated; and
a delay unit, the delay unit delaying application of the program counter address to the register.

2. The apparatus as recited in claim 1 further comprising a read bus, wherein a second control signal causes the contents of the register to be applied to the read bus.

3. The apparatus as recited in claim 1 wherein a state machine is an event generation unit.

4. The apparatus as recited in claim 1 further comprising:
a second register, the second register responsive to the control signal for storing indicia of the events signals.

5. The method of storing a program counter address related to the generation of a trigger signal, the method comprising:
generating a event signal for each predetermined event;
applying each event signal to a trigger generation unit;
when a predetermined event signal or combination of event signals is applied to the trigger generation unit, the trigger generation unit providing a trigger signal and a trigger control signal; and
applying the trigger control signal to the storage unit, the storage unit storing the program counter address resulting in the generation of the trigger signal in the storage unit in response to the trigger control signal.

6. The method as recited in claim 5 further comprising the step of delaying the program counter address applied to the storage unit.

7. The method as recited in claim 6 wherein the storage unit is a register.

8. The method as recited in claim 6 wherein a control signal applies the contents of the storage unit to a read bus.

9. The method as recited in claim 4 further comprising storing indicia of each event signal resulting in the trigger signal in a second register in response to the trigger control signals.

10. A target processor comprising:
a state machine, the state machine generating a first event signal in response to a configuration of the target processor;
at least one event detection unit, each event detection unit responsive to predetermined configuration of the target processing unit for generating a related event signal;
a trigger generation unit, the trigger generation unit generating trigger signal in response to at least one of the first and the related event signals, the trigger unit generating a trigger control signal when the a trigger signal is generated; and
a storage unit, the storage unit coupled to the program counter, the program counter applying address signals to the storage unit, the storage unit storing a program counter address in response to the trigger control signal.

11. The target processor as recited in claim 10 further comprising a delay line, the delay line delaying the application of the program counter address to the storage unit for a predetermined period of time.

12. The target processor as recited in claim 10 further comprising a read bus coupled to the storage unit, the program counter address stored in the storage unit being applied to the read bus in response to a second control signal.

13. The target processing unit as recited in claim 11 wherein the storage unit is a register.

14. The target processor as recited in claim 11 further comprising a second register, the second storage unit having each event signal applied to at least one associated storage unit position, the storage unit storing applied signals in response to the trigger control signal.
